(19) United States
(12) Patent Application Publication
(10) Pub. No.: US 2017/0148113 A1
(43) Pub. Date: May 25, 2017

(54) METHOD AND SYSTEM FOR FUELING A VEHICLE BASED ON A VEHICLE FUEL TRIGGER

(71) Applicant: Verizon Patent and Licensing, Inc., Arlington, VA (US)

(72) Inventor: Christopher Yasko, Milton, GA (US)

(21) Appl. No.: 14/946,047

(22) Filed: Nov. 19, 2015

(51) Int. Cl. G06Q 50/06; G06Q 40/04

(52) U.S. Cl. CPC G06Q 50/06; G06Q 40/04; G07C 5/0808

(57) ABSTRACT

A computer device, located inside a vehicle, may include logic configured to detect a re-fueling trigger for the vehicle and may send a fuel bid request to a fuel auction system for fuel prices within a geographic area of the vehicle. The computer device may receive information relating to a fuel price reverse auction generated by the fuel auction system; generate a user interface that displays the received information that includes variable discount fuel prices associated with a plurality of fueling stations within the geographic area; receive information relating to the results of the fuel price reverse auction from the fuel auction system; display the results of the fuel price reverse auction in the generated user interface; and receive selection of a fueling station via the user interface based on the results.

### BACKGROUND INFORMATION

A vehicle may include a computer device that collects information relating to the vehicle. For example, the computer device may collect information relating to the number of miles the vehicle was driven in a particular time period, the times during the vehicle was driven, or a current location of the vehicle. Such information may be collected for a variety of purposes, including for providing a variety of services to subscribers or customers.

### BRIEF DESCRIPTION OF THE DRAWINGS

FIG. 1 is a diagram illustrating an environment according to an implementation described herein;

FIG. 2 is a diagram illustrating exemplary components of a device included in the on-board diagnostics device, user device, or vehicle computer of FIG. 1;

FIG. 3 is a diagram illustrating exemplary components of the device of FIG. 2;

FIG. 4 is a diagram illustrating exemplary components of the fuel auction system of FIG. 1;

FIG. 5 is a diagram illustrating exemplary components of the fuel auction system of FIG. 1;

FIG. 6A is a diagram illustrating exemplary components that may be stored in the user database 350 of FIG. 3;

FIG. 6B is a diagram illustrating exemplary components that may be stored in the auction database 570 of FIG. 5;

FIG. 7 is a flowchart of a first process for obtaining a fuel discount according to an implementation described herein;

FIG. 8 is a flowchart of a process for generating a fuel discount using a reverse auction according to an implementation described herein;

FIG. 9 is a flowchart of a second process for obtaining a fuel discount according to an implementation described herein;

FIG. 10 is a flowchart of a third process for obtaining a fuel discount according to an implementation described herein;

FIG. 11 is an exemplary signal flow diagram according to an implementation described herein;

FIG. 12A is a diagram of a first exemplary user interface according to an implementation described herein; and

FIG. 12B is a diagram of a second exemplary user interface according to an implementation described herein.

### DETAILED DESCRIPTION OF PREFERRED EMBODIMENTS

The following detailed description refers to the accompanying drawings. The same reference numbers in different drawings identify the same or similar elements.

A user driving a telematics-enabled vehicle may need to re-fuel the vehicle when the fuel level drops below a particular fuel level. Fuel prices may be continuously changing due to the price of fuel (e.g., gasoline, diesel, etc.) and may vary across different fueling stations in an area. Furthermore, a user may be in an unfamiliar area and may not know the locations of fueling stations in the area. Moreover, the user may have a relationship with a particular fuel supplier, which may enable the user to receive a discount. Different fuel suppliers may be willing to offer a discount in order to attract the user's business. However, the fuel suppliers may be unaware of the user's location or that the user is looking to re-fuel the vehicle at a particular time. Implementations described herein relate to systems and method for matching fueling suppliers and/or fueling stations with a user looking to re-fuel a vehicle in order enable the user to obtain a virtual mobile fuel discount.

A fueling application may be installed on a computer device located inside a vehicle. The computer device may be an embedded telematics device with a dashboard display, an aftermarket on-board diagnostics (OBD) device plugged into an OBD, OBD-II, or similar port of the vehicle, and/or a portable wireless communication device (e.g., a mobile phone, tablet, etc.) associated with a user within the vehicle. In some implementations, the fueling application may be part of another device in the vehicle, such as, for example, an entertainment head unit built into the vehicle, or part of a user's mobile device, such as a wireless smartphone or tablet. The fueling application may communicate with a fuel auction system over a network using wireless signals, in order to identify a best fuel price for the user and/or to enable the user to negotiate the best price based on the location of the vehicle and/or based on information associated with the user, and/or based on vehicle information retrieved from the embedded telematics or OBD-II-connected device. Thus, the fueling application may provide a variable fuel discount in real-time for a user in a telematics-enabled vehicle based on user information, vehicle information, vehicle diagnostic information, vehicle location, and/or user input.

The computer device may detect a re-fueling trigger for the vehicle. The re-fueling trigger may include detection of the activation of a low fuel level indicator, detection of a particular level of fuel in the vehicle, activation of a re-fueling dashboard button and/or another type of re-fueling command initiated by the user (e.g., a voice command spoken by the user), activation of the fueling application, detection of a geo-fence associated with a fueling station, detection of a geo-fence based on a previous fueling event, determination of a predetermined number of miles since a previous, or a most-recent, fueling event, and/or another type of re-fueling trigger. In response, the computer device may send a fuel bid request to the fuel auction system.

The fuel auction system may obtain location information for the vehicle. For example, in some implementations, the location information may be included in the fuel bid request. In other implementations, the location information may be obtained from a telematics system configured to receive telematics information from the vehicle. The fuel auction system may identify fueling stations within a particular range of the vehicle's locations and may identify fuel suppliers for the identified fueling stations (e.g., BP®, Exxon Mobil®, Chevron®, Sunoco®, etc.). The fuel auction system may obtain advertised fuel prices from the identified fuel suppliers and may provide the advertised prices to the computer device. The computer device may generate a user interface and may display the advertised prices.

Furthermore, the fuel auction system may obtain user information, including demographic information, relating to a user associated with the vehicle and/or associated with the computer device. The user information may include, for example, information identifying the user and/or information identifying one or more fuel supplier accounts associated with the user. For example, the user may have a fuel discount card or a rewards card associated with a particular fuel supplier. The user information may include additional information, such as fuel preferences associated with the user, vehicle performance information, and/or vehicle status information. The fuel auction system may obtain personalized prices from the fuel suppliers based on the user information and may provide the personalized prices to the computer device. The personalized prices may include, for example, a discount to the user based on the user's account. The computer device may display the personalized prices in the generated user interface.

Moreover, the fuel auction system may generate a fuel price reverse auction for the user and may provide information relating to the generated fuel price reverse auction to the computer device. The computer device may receive and display the information relating to the fuel price reverse auction in the generated user interface. In a reverse auction, sellers compete to obtain business from a buyer by bidding to decrease the price until a single seller, willing to offer the lowest price, remains, or until an allotted auction time period ends and a seller with the lowest offered price is declared the winner. The fuel auction system may send requests to the identified fuel supplier, prompting the fuel supplier to offer a lower price in order to obtain the user's business when the user re-fuels the vehicle. The requests sent to the one or more fuel supplies may include the user historical information and/or vehicle historical information, which the one or more fuel supplies may use in determining a unit price to bid in the reverse auction. For example, if user and/or vehicle information contained in the request indicates that a driver or passenger of the vehicle has not eaten for five hours, the fuel supplier's nearby retail outlet includes a restaurant, and the vehicle is a heavy truck with a large tank that needs to be replenished with diesel fuel, the offer price might be lower than if the vehicle associated with the request is small diesel sedan (that would have a much smaller tank to replenish) or if the user information indicates that the driver and passenger(s) have stopped at a restaurant location recently.

As the fuel suppliers generate offers to lower the price, the fuel auction system may forward to offers to the computer device. The computer device may display the received offers and may thus display variable discount fuel prices in real-time as the reverse auction progresses. The reverse auction may run for a particular length of time or until a single seller remains. The fuel auction system may determine the results of the fuel price reverse auction and may provide the results to the computer device. The computer device may display the results.

In some implementations, the user may select to order the displayed results of fueling station fuel prices based on one or more parameters. For example, the user may select to order the results based on price, based on distance to the user's vehicle, based on the user's fuel brand preferences, based on a subsidized or advertised fuel brand given preference, and/or based on another parameter, such as a nearby point of interest or proximity to a restaurant. Furthermore, the fuel auction system may communicate with the identified fueling stations and may obtain additional discounts, offers, and/or coupons from particular fueling station. For example, a fueling station may have excess fuel of a particular grade or may be experiencing a decrease in business and may select to offer an additional fuel discount to the user. Additionally, or alternatively, the fueling station may offer a coupon or discount on other products or services to attract the user's business. The fuel auction system may forward the discounts, offers, and/or coupons to the computer device and the computer device may display the received discounts, offers and/or coupons in the user interface.

In some implementations, the fueling application may display additional information in the user interface. For example, the fueling application may determine fuel preferences (e.g., preferred fuel brand, preferred fuel grade, etc.) associated with the user and may adjust the user interface based on the user's preferences. As an example, for a particular fueling station, the user interface may display an offered price associated with the particular fueling station, a fuel supplier associated with the fueling station, a distance to the particular fueling station, a coupon associated with the particular fueling station, a number of unoccupied vehicle fueling spots associated with the particular fueling station, whether the particular fueling station is on the same side of the street as the vehicle, whether the particular fueling station is in a direction of travel, and/or other types of information. As another example, the user interface may display information relating the traveling direction and/or speed of the vehicle. As yet another example, the user interface may display vehicle performance data relating to fueling station services based on available telematics and/or vehicle performance information. For example, the user interface may inform the user that the oil pressure is low, that the tire pressure is low, etc.

The user may select a particular fueling station based on the received offers, such as the results of the reverse auction and/or based on offers from particular fueling stations. In response, the fueling application may generate navigation information to direct the user to drive the vehicle to the selected fueling station. Furthermore, the fueling application may send the user's selection to the fuel auction system. The fuel auction system may process a fueling transaction between the selected fueling station and the user associated with the user device. As an example, the fuel auction system may send a payment for the fueling transaction to the selected fueling station and may bill a wireless communication account associated with the user device. As another example, the fuel auction system may apply a discount to a bill associated with the wireless communication account based on the fueling transaction.

In some implementations, the fueling application may be configured to enable the user to request a particular price. The user may enter a particular requested fuel price and the fuel application may send the requested fuel price to the fuel auction system. The fuel auction system may forward the requested fuel price to the identified fuel suppliers and may receive a response that a fuel supplier either accepted or rejected the requested fuel price. If the requested fuel price was rejected, the user may be prompted to adjust the requested fuel price or may be provided with information identifying the best available price.

In some implementations, the computer device may be configured to communicate directly with fueling stations within the geographic area of the vehicle. For example, the computer device may identify a fueling station within wireless communication range, may send a fuel price offer request to the identified fueling station, and may receive a fuel price offer from the identified fueling station, in response to the fuel price offer request. Additionally, or alternatively, the fueling application may identify multiple fueling stations and may generate a fuel price reverse auction with the identified fueling stations in order to determine which fueling station is willing to offer the best fuel price.

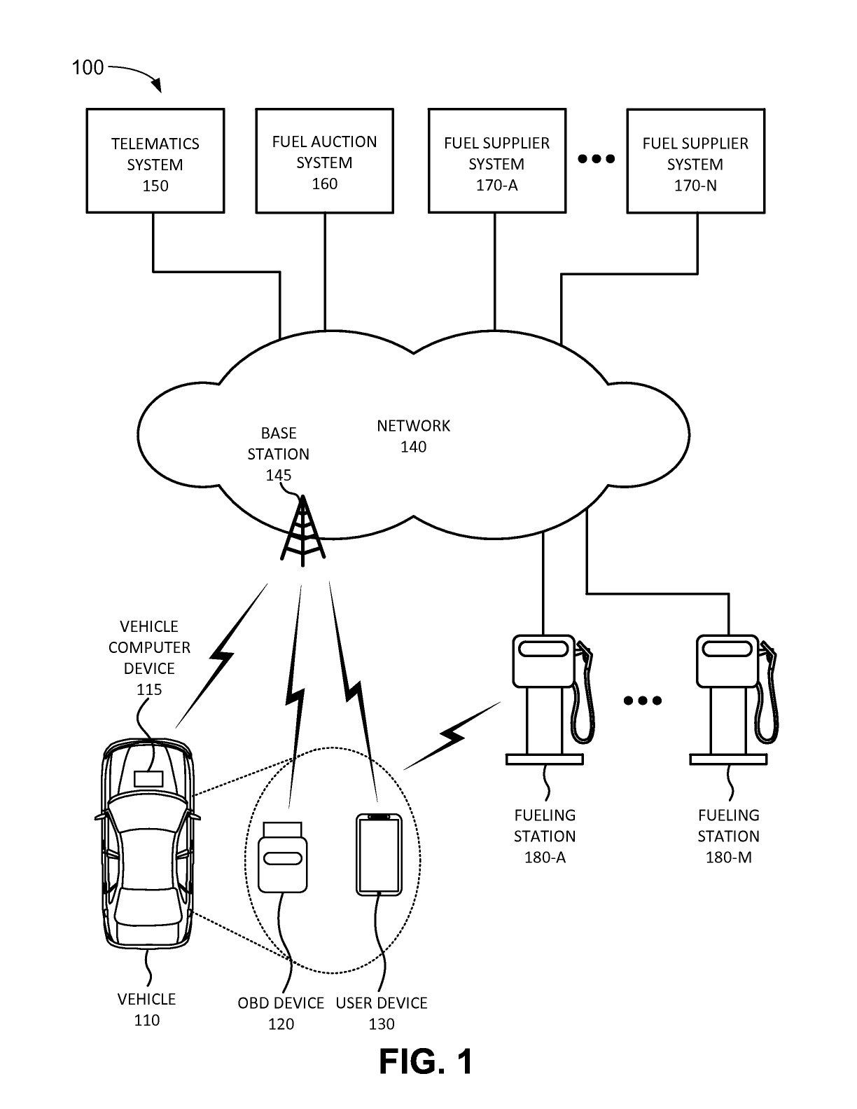

FIG. 1 is a diagram illustrating exemplary components of an environment 100 according to an implementation described herein. As shown in FIG. 1, environment 100 may include a vehicle 110, an on-board diagnostics (OBD) device 120, a user device 130, a network 140, a telematics system 150, a fuel action system 160, one or more fuel supplier systems 170-A to 170-N (referred to herein collectively as “fuel supplier systems 170” and individually “fuel supplier system 170”), and one or more fueling stations 180-A to 180-M (referred to herein collectively as “fueling stations 180” and individually “fueling station 180”).

Vehicle 110 may include a sedan, a sports utility vehicle (SUV), a truck, a van, and/or another type of vehicle. Vehicle 110 may include a user's personal vehicle, a business vehicle, a rental vehicle, and/or a vehicle used for another purpose by a user. Vehicle 110 may require fuel, such as gasoline, diesel, or another type of fuel. Vehicle 110 may include a vehicle computer device 115.

Vehicle computer device 115 may manage one or more functions of vehicle 110 and/or may collect information relating to vehicle 110. As an example, vehicle computer device 115 may manage the functionality of various components of vehicle 110. As another example, vehicle computer device 115 may include an embedded telematics device, or an aftermarket device coupled to the vehicle's diagnostic port, configured to collect or calculate telematics data (e.g., data relating to the status of the components of vehicle 110, error codes received from components of vehicle 110, telematics data such as the location of vehicle 110, the speed of vehicle 110, the miles per gallon fuel consumption of vehicle 110, etc.). Vehicle computer device 115 may obtain sensor information from one or more sensors located in vehicle 110, such as an accelerometer, a fuel sensor, an engine diagnostics device, and/or other types of sensors.

OBD device 120 may include a device, such as a dongle device, that may be plugged into an OBD port in vehicle 110, such as an OBD-II port or another type of OBD port. The OBD port may be located, for example, inside vehicle 110, such as on the dashboard, under the steering wheel, or in another location. OBD device 120 may interface with vehicle computer device 115 and/or with other vehicle components of vehicle 110, may obtain diagnostics and/or telematics information about vehicle 110, and my report the obtained information to telematics system 150.

User device 130 may be associated with a driver of vehicle 110 or with one of the passengers. User device 130 may include a handheld portable wireless communication device (e.g., a mobile phone, a smart phone, etc.), a tablet computer, a laptop computer, a phablet computer device, a wearable computer device (e.g., a glasses smartphone device, a wristwatch smartphone device, a smart pendant, etc.), and/or any other type of mobile computer device with wireless communication and output capabilities. User device 130 may communicate with OBD device 120, and/or with vehicle computer device 115, using a short range wireless communication protocol (e.g., Bluetooth, WiFi, etc.). Additionally or alternatively, user device 130 may be tethered to the dashboard of vehicle 110 via a wired connection, such as via a Universal Serial Bus (USB) to a USB port in the dashboard. User device 130 may exchange information with vehicle computer device 115 and/or OBD device 120 via the wireless or wired connection. For example, user device 130 may provide user information, user requests, and/or user selections to vehicle computer device 115 and/or OBD device 120 and/or may obtain and display information from vehicle computer device 115 and/or OBD device 120.

Network 140 may include one or more circuit-switched networks and/or packet-switched networks. For example, network 140 may include a local area network (LAN), a wide area network (WAN), a metropolitan area network (MAN), a Public Switched Telephone Network (PSTN), an ad hoc network, an intranet, the Internet, a fiber optic-based network, a wireless network, a satellite network, and/or a combination of these or other types of networks. Network 140 may include base station 145. Base station 145 may function as a base station that enables vehicle computer device 115, OBD device 120, and/or user device 130 to wirelessly communicate with network 140. For example, base station 145 may include a Long Term Evolution eNodeB base station, a Global System for Mobile Communications (GSM) base station, a Code Division Multiple Access (CDMA) base station, and/or another type of base station.

Telematics system 150 may include one or more devices, such as computer devices and/or server devices, which are configured to receive telematics information from OBD device 120 and/or from vehicle computer device 115. Telematics system 150 may provide telematics information relating to vehicle 110 to fuel auction system 160. Additionally, or alternatively, the telematics information may be provided by OBD device 120 and/or by vehicle computer device 115 directly to fuel action system 160. The telematics information may include, for example, the location of vehicle 110, the speed and/or direction of vehicle 110, the fuel performance of vehicle 110, the fuel level of vehicle 110, an odometer reading associated with vehicle 110, vehicle performance information associated with vehicle 110 (oil pressure, oil temperature, coolant temperature, battery voltage, emission status, etc.), vehicle status information associated with vehicle 110 (e.g., OBD trouble codes, malfunction indicator light (MIL) status, etc.), a type of vehicle for vehicle 110 (e.g., sedan, Sport Utility Vehicle, truck, commercial freighter truck, etc.), a size of a fuel tank for vehicle 110, and/or other types of telematics information. Additionally, the telematics information may include information relating to a most recent stop of vehicle 110 (e.g., where vehicle 110 stopped, how long ago vehicle 110 stopped, the amount of time that vehicle 110 was stopped, etc.) and/or anonymized demographic information relating a user of vehicle 110 (e.g., age, sex, marital status, income level, etc.).

Fuel auction system 160 may include one or more devices, such as computer devices and/or server devices, which are configured to receive a fuel price bid request from a computer device corresponding to vehicle computer device 115, OBD device 120, and/or user device 130, may obtain telematics information for vehicle 110, may identify fueling stations 180 within a geographic range of vehicle 110 based on the obtained telematics information, may identify fuel supplier systems 170 associated with the identified fueling stations 180, may obtain fuel price information from the identified fuel supplier systems 170, and may provide the obtained fuel price information to the computer device. Moreover, fuel auction system 160 may obtain user information from the computer device, may obtain personalized fuel price offers from one or more of the identified fueling stations 180, and may provide the personalized fuel price offers to the computer device. Furthermore, fuel auction system 160 may generate a fuel price reverse auction based on the received fuel price bid request, may obtain bids for the fuel price reverse auction from the identified fuel supplier systems 170, may determine the results of the fuel price reverse auction based on the bids, and may provide information relating to the fuel price reverse auction and the results to the computer device. In some implementations, fuel auction system 160 may also obtain user information from third party sources (not shown in FIG. 1), such as a system associated with managing a loyalty program in which the user is participating, a system managing a credit card account associated with the user, and/or other types of systems that may manage user information.

Fuel supplier system 170 may include one or more devices, such as computer devices and/or server devices, which are associated with a particular fuel supplier (e.g., BP®, Exxon Mobil®, Chevron®, Sunoco®, etc.). Fuel supplier system 170 may store information relating to fuel prices being charged to fueling stations for fuel supplied by the particular fuel supplier. Furthermore, fuel supplier system 170 may store information relating to user accounts. For example, a user account for a particular user may include information identifying the particular user, information relating to fueling transactions associated with the particular user, demographic information associated with the user, information relating to vehicle 110, and/or other type of user information. Fuel supplier system 170 may receive a request for a fuel price and/or fuel discount from fuel auction system 160 and may provide a fuel price offer. The fuel price offer may be based on information associated with the user. In some implementations, fuel supplier system 170 may also obtain user information from third party sources (not shown in FIG. 1), such as a system associated with managing a loyalty program in which the user is participating, a system managing a credit card account associated with the user, and/or other types of systems that may manage user information.

Fueling station 180 may correspond to a fueling station that includes one or more pumps to re-fuel vehicle 110. Fueling station 180 may be associated with a particular fuel supplier. Fueling station 180 may sell fuel of different types and/or different grades and may base the fuel price for the different types and/or grades of fuel based on a price set by the particular fuel supplier. For example, fueling station 180 may sell gasoline and/or diesel fuel. Additionally or alternatively, fueling station 180 may sell one or more alternative fuels, such as hydrogen fuel cells, bio diesel fuel, electricity for electric vehicles, and/or other types of fuel. Fueling station 180 may include a service shop and/or a retail store that offer products and services related to re-fueling and/or may sell food and drink. Fueling station 180 may provide a fuel discount, and/or a coupon or offer, to a user, either via fuel auction system 160 or directly via a wireless communication method.

Although FIG. 1 shows exemplary components of environment 100, in other implementations, environment 100 may include fewer components, different components, differently arranged components, or additional components than depicted in FIG. 1. Additionally, or alternatively, one or more components of environment 100 may perform functions described as being performed by one or more other components of environment 100.

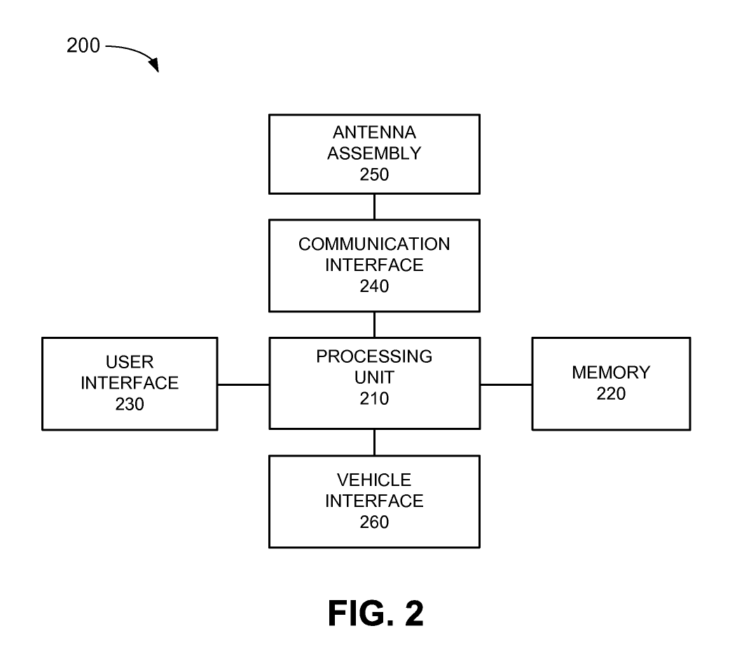

FIG. 2 is a diagram illustrating exemplary components of device 200 according to an implementation described herein. Vehicle computer device 115, OBD device 120, and/or user 130 may each include one or more devices 200. As shown in FIG. 2, device 200 may include a processing unit 210, a memory 220, a user interface 230, a communication interface 240, an antenna assembly 250, and a vehicle interface 260.

Processing unit 210 may include one or more processors, microprocessors, application specific integrated circuits (ASICs), field programmable gate arrays (FPGAs), and/or other processing logic. Processing unit 210 may control operation of device 200 and its components.

Memory 220 may include a random access memory (RAM) or another type of dynamic storage device, a read only memory (ROM) or another type of static storage device, a removable memory card, and/or another type of memory to store data and instructions that may be used by processing unit 210.

User interface 230 may allow a user to input information to device 200 and/or to output information from device 200. Examples of user interface 230 may include a speaker to receive electrical signals and output audio signals; a camera to receive image and/or video signals and output electrical signals; a microphone to receive sounds and output electrical signals; buttons (e.g., a joystick, control buttons, a keyboard, or keys of a keypad) and/or a touchscreen to receive control commands; a display, such as an LCD, to output visual information; an actuator to cause device 200 to vibrate; a sensor; and/or any other type of input or output device.

Communication interface 240 may include a transceiver that enables device 200 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 240 may include a transmitter that converts baseband signals to radio frequency (RF) signals and/or a receiver that converts RF signals to baseband signals. Communication interface 240 may be coupled to antenna assembly 250 for transmitting and receiving RF signals.

Communication interface 240 may include a logical component that includes input and/or output ports, input and/or output systems, and/or other input and output components that facilitate the transmission of data to other devices. For example, communication interface 240 may include a network interface card (e.g., Ethernet card) for wired communications and/or a wireless network interface (e.g., a WiFi) card for wireless communications. Communication interface 240 may also include a universal serial bus (USB) port for communications over a cable, a Bluetooth® wireless interface, a radio-frequency identification (RFID) interface, a near-field communications (NFC) wireless interface, and/or any other type of interface that converts data from one form to another form.

Antenna assembly 250 may include one or more antennas to transmit and/or receive RF signals. Antenna assembly 250 may, for example, receive RF signals from communication interface 240 and transmit the signals via an antenna and receive RF signals from an antenna and provide them to communication interface 240.

As described herein, device 200 may perform certain operations in response to processing unit 210 executing software instructions contained in a computer-readable medium, such as memory 220. A computer-readable medium may be defined as a non-transitory memory device. A non-transitory memory device may include memory space within a single physical memory device or spread across multiple physical memory devices. The software instructions may be read into memory 220 from another computer-readable medium or from another device via communication interface 240. The software instructions contained in memory 220 may cause processing unit 210 to perform processes that will be described later. Alternatively, hardwired circuitry may be used in place of, or in combination with, software instructions to implement processes described herein. Thus, implementations described herein are not limited to any specific combination of hardware circuitry and software.

Vehicle interface 260 may include one or more ports and associated logic to communicate with vehicle sensors and/or diagnostic device, if device 200 is included in vehicle computer device 115. If device 200 is included in OBD device 120, vehicle interface 260 may communicate with vehicle computer device 115 and/or other electronic components of vehicle 110. For example, vehicle interface 260 may include an OBD II port and/or another type of vehicle interface. If device 200 is included in user device 130, vehicle interface 260 may include to logic configured to implement an application programming interface (API) to communicate with vehicle computer device 115 and/or with OBD device 120 using a wireless communication method. Additionally or alternatively, vehicle interface may include logic configured to implement a Control Area Network (CAN) bus interface and/or an in-vehicle infotainment software stack for managing and playing audio content, providing navigation and/or traffic information, providing weather information, delivering rear-seat entertainment, sending or receiving Short Message Service (SMS) messages, placing or receiving voice telephone calls, etc.

Although FIG. 2 shows exemplary components of device 200, in other implementations, device 200 may include fewer components, different components, differently arranged components, or additional components than those depicted in FIG. 2. Additionally, or alternatively, one or more components of device 200 may perform the tasks described as being performed by one or more other components of device 200.

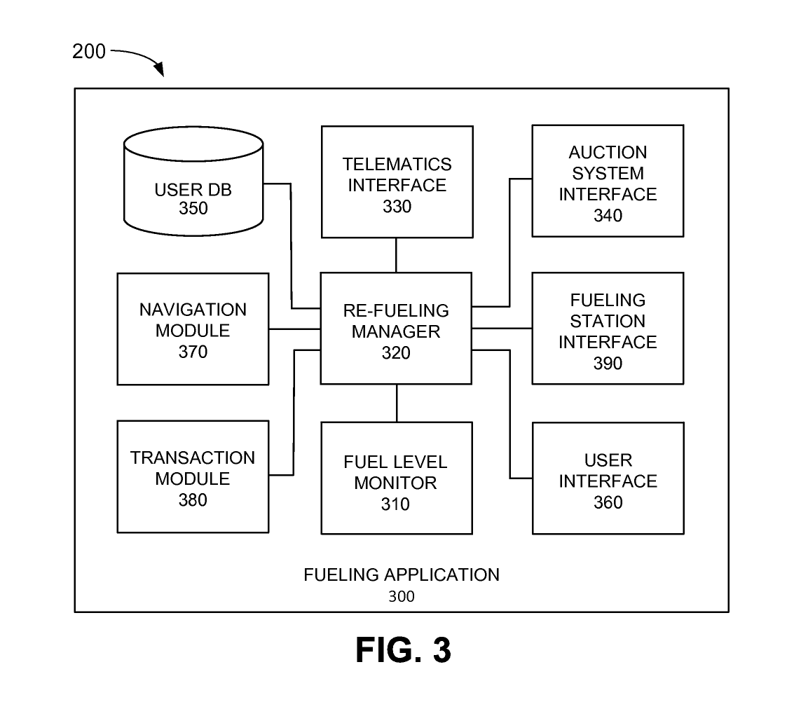

FIG. 3 is a diagram illustrating exemplary functional components of device 200 according to a first implementation described herein. As shown in FIG. 3, device 200 may include a fueling application 300. Fueling application 300 may be implemented, for example, via processing unit 210 of device 200 (e.g., OBD device 120, vehicle computer device 115, user device 130, etc.) executing instructions from memory 220. Alternatively, some or all of the functionality of fueling application 300 may be implemented via hard-wired circuitry. In other implementations, some or all of the functionality of fueling application 300 may be implemented via fuel auction system 160.

As shown in FIG. 3, fueling application 300 may include a fuel level monitor 310, a re-fueling manager 320, a telematics interface 330, an auction system interface 340, a user database (DB) 350, a user interface 360, a navigation module 370, and a transaction module 380.

Fuel level monitor 310 may monitor the fuel level of vehicle 110 and may generate a re-fueling trigger when the fuel level of vehicle 110 drops below a particular fuel level (e.g., one fourth the fuel tank capacity, one eighth the fuel tank capacity, etc.) based on detecting the activation of a low fuel level indicator; based on detecting of activation of a re-fueling dashboard button by the user; based on detecting activation of a fueling application; detection of a fueling station geo-fence associated with fueling station 180; and/or based on another type of re-fueling trigger, such as the additional types of triggers discussed above.

Re-fueling manager 320 may activate a re-fueling process based on a re-fuel trigger detected by fuel level monitor 310. For example, re-fueling manager 320 may send a fuel price bid request to fuel auction system 160. Re-fueling manager 320 may receive information relating to fuel price offers from fuel auction system 160, may generate a visual layout for a user interface based on the received information, and may provide the generated visual layout to user interface 360.

Telematics interface 330 may be configured to communicate with telematics system 150. For example, telematics interface 330 may provide, at particular intervals or in response to a particular telematics trigger events (e.g., crossing a particular geo-fence), telematics information associated with vehicle 110. Auction system interface 340 may be configured to communicate with fuel auction system 160. For example, auction system interface 340 may send fuel price bid requests to fuel auction system 160 and may receive information relating to identified fueling stations 180 and/or associated fuel price offers from fuel auction system 160.

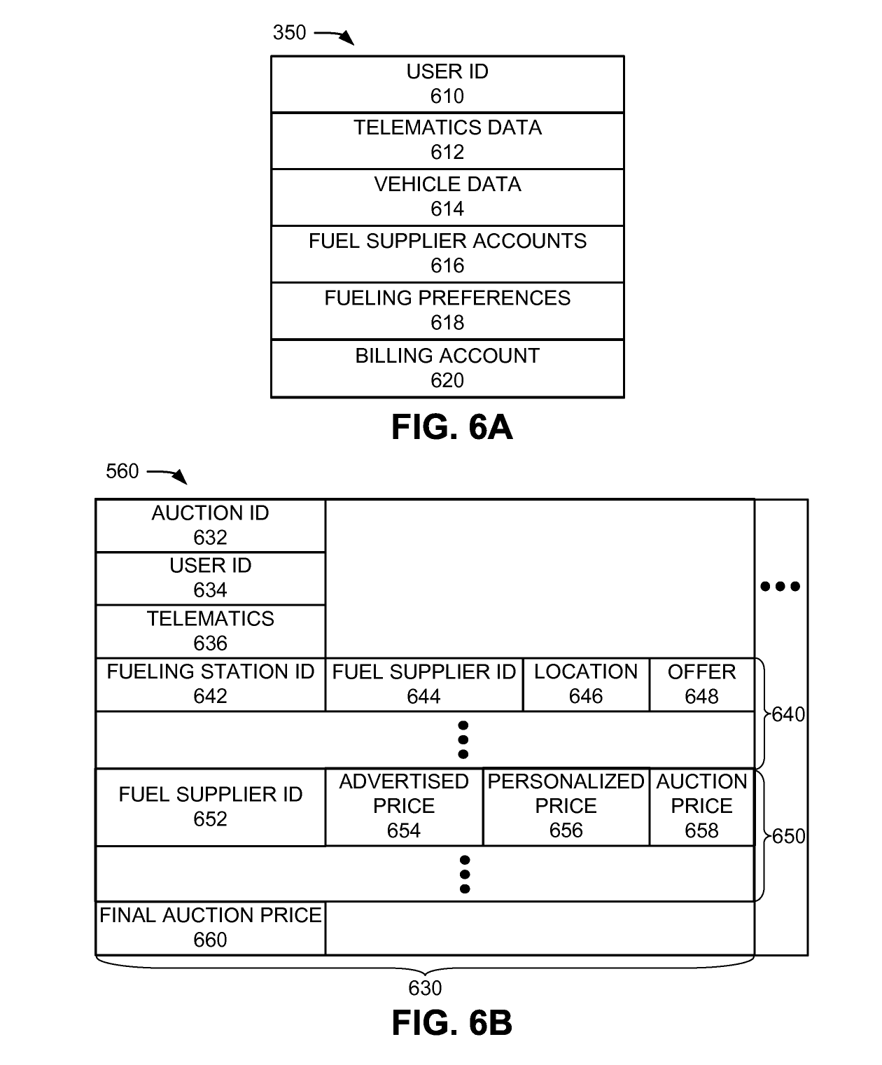

User DB 350 may store information relating to the user of vehicle 110. Exemplary information that may be stored in user DB 350 is described below with reference to FIG. 6A.

User interface 360 may generate and display a user interface that includes information relating to identified fueling stations 180 and/or offered fuel prices associated with the identified fueling stations 180. User interface 360 may update the offered prices based on the progress of a reverse auction generated by fuel auction system 160. User interface 360 may include other types of information, such as other information associated with identified fueling stations 180, vehicle performance and/or vehicle telematics information associated with vehicle 110, and/or other types of information. Furthermore, user interface 360 may enable user to input selections, such as a selection of a particular fueling station 180 based on an offered fuel price.

Navigation module 370 may generate navigation instructions to a selected fueling station 180. In some implementations, navigation module 370 may interface with a navigation and/or map application and may provide location information associated with a selected fueling station 180 to the navigation application. In other implementations, navigation module 370 may include a navigation and/or map application and may generate the navigation instructions to the selected fueling station 180.

Transaction module 380 may process a fueling transaction between the user of vehicle 110 and the selected fueling station 180. As an example, transaction module 380 may provide identification, authentication, and/or authorization information associated with the user to fuel auction system 160, or to another billing system, to send payment to the selected fueling station 180 and/or to bill an account associated with the customer, such as wireless communication account associated with vehicle computer device 115, OBD device 120, and/or user device 130. As another example, transaction module 380 may credit an account based on a difference between the price paid for the fuel at the fueling station 180 and the offered price based on the result of a reverse auction generated by fuel auction system 160.

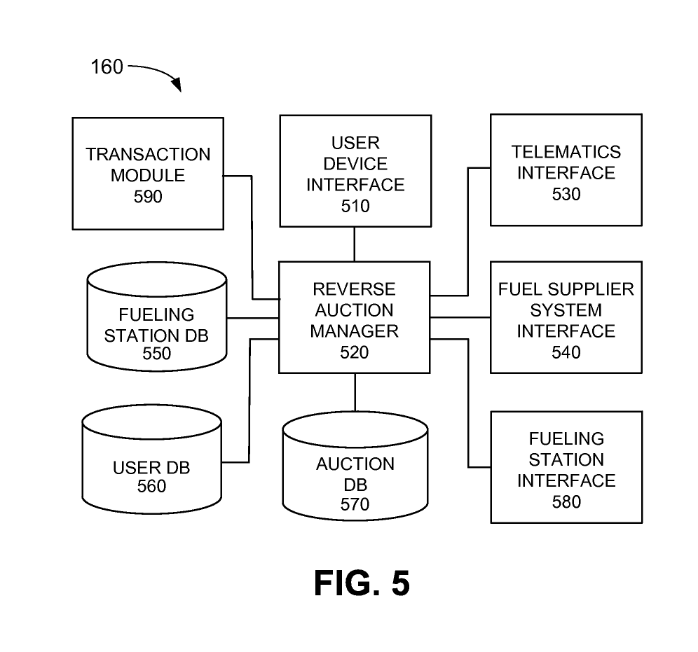

Although FIG. 3 shows exemplary functional components of fueling application 300, in other implementations, fueling application 300 may include fewer functional components, different functional components, differently arranged functional components, or additional functional components than depicted in FIG. 3. Additionally, or alternatively, one or more functional components of fueling application 300 may perform functions described as being performed by one or more other functional components of fueling application 300. For example, in some implementations, fueling application 300 may communicate directly with fuel supplier systems 170 and may generate a reverse auction with fuel supplier systems 170 without the participation of fuel auction system 160. Thus, in some implementations, some or all of the functionality of fuel auction system 160 (e.g., as described below with reference to FIG. 5) may be implemented in fueling application 300.

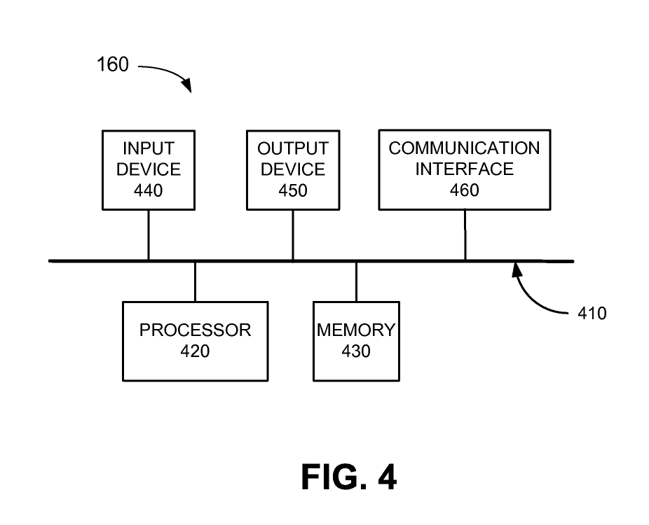

FIG. 4 is a diagram illustrating exemplary components of fuel auction system 160 according to an implementation described herein. As shown in FIG. 4, fuel auction system 160 may include a bus 410, a processor 420, a memory 430, an input device 440, an output device 450, and a communication interface 460.

Bus 410 may include a path that permits communication among the components of fuel auction system 160. Processor 420 may include any type of single-core processor, multi-core processor, microprocessor, latch-based processor, and/or processing logic (or families of processors, microprocessors, and/or processing logics) that interprets and executes instructions. In other embodiments, processor 420 may include an application-specific integrated circuit (ASIC), a field-programmable gate array (FPGA), and/or another type of integrated circuit or processing logic.

Memory 430 may include any type of dynamic storage device that may store information and/or instructions, for execution by processor 420, and/or any type of non-volatile storage device that may store information for use by processor 420. For example, memory 430 may include a random access memory (RAM) or another type of dynamic storage device, a read-only memory (ROM) device or another type of static storage device, a content addressable memory (CAM), a magnetic and/or optical recording memory device and its corresponding drive (e.g., a hard disk drive, optical drive, etc.), and/or a removable form of memory, such as a flash memory.

Input device 440 may allow an operator to input information into telematics system 150. Input device 440 may include, for example, a keyboard, a mouse, a pen, a microphone, a remote control, an audio capture device, an image and/or video capture device, a touch-screen display, and/or another type of input device. In some embodiments, fuel auction system 160 may be managed remotely and may not include input device 440. In other words, fuel auction system 160 may be “headless” and may not include a keyboard, for example.

Output device 450 may output information to an operator of fuel auction system 160. Output device 450 may include a display, a printer, a speaker, and/or another type of output device. For example, fuel auction system 160 may include a display, which may include a liquid-crystal display (LCD) for displaying content to the customer. In some embodiments, telematics system 150 may be managed remotely and may not include output device 450. In other words, fuel auction system 160 may be “headless” and may not include a display, for example.

Communication interface 460 may include a transceiver that enables fuel auction system 160 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 460 may include a transmitter that converts baseband signals to radio frequency (RF) signals and/or a receiver that converts RF signals to baseband signals. Communication interface 460 may be coupled to an antenna for transmitting and receiving RF signals.

Communication interface 460 may include a logical component that includes input and/or output ports, input and/or output systems, and/or other input and output components that facilitate the transmission of data to other devices. For example, communication interface 460 may include a network interface card (e.g., Ethernet card) for wired communications and/or a wireless network interface (e.g., a WiFi) card for wireless communications. Communication interface 460 may also include a universal serial bus (USB) port for communications over a cable, a Bluetooth™ wireless interface, a radio-frequency identification (RFID) interface, a near-field communications (NFC) wireless interface, and/or any other type of interface that converts data from one form to another form.

As will be described in detail below, fuel auction system 160 may perform certain operations relating to determining the number of people in a vehicle and/or reporting the number of people in the vehicle. Fuel auction system 160 may perform these operations in response to processor 420 executing software instructions contained in a computer-readable medium, such as memory 430. A computer-readable medium may be defined as a non-transitory memory device. A memory device may be implemented within a single physical memory device or spread across multiple physical memory devices. The software instructions may be read into memory 430 from another computer-readable medium or from another device. The software instructions contained in memory 430 may cause processor 420 to perform processes described herein. Alternatively, hardwired circuitry may be used in place of, or in combination with, software instructions to implement processes described herein. Thus, implementations described herein are not limited to any specific combination of hardware circuitry and software.

Although FIG. 4 shows exemplary components of fuel auction system 160, in other implementations, fuel auction system 160 may include fewer components, different components, additional components, or differently arranged components than those depicted in FIG. 4. Additionally or alternatively, one or more components of fuel auction system 160 may perform one or more tasks described as being performed by one or more other components of fuel auction system 160.

FIG. 5 is a diagram illustrating exemplary functional components of fuel auction system 160 according to a first implementation described herein. The functional components of fuel auction system 160 may be implemented, for example, via processor 420 executing instructions from memory 430. Alternatively, some or all of the functional components of fuel auction system 160 may be implemented via hard-wired circuitry. As shown in FIG. 5, fuel auction system 160 may include a user device interface 510, a reverse auction manager 520, a telematics interface 530, a fuel supplier system interface 540, a fueling station DB 550, a user DB 560, an auction DB 570, a fueling station interface 580, and a transaction module 590.

User device interface 510 may be configured to communicate with vehicle computer device 115, OBD device 120, and/or user device 130. For example, user device interface 510 may receive a fuel price bid request from vehicle computer device 115, OBD device 120, and/or user device 130 and/or may provide fuel price offers to vehicle computer device 115, OBD device 120, and/or user device 130.

Reverse auction manager 520 may generate and run a reverse auction for fuel prices for a user associated with vehicle 110. Reverse auction manager 520 may prompt fuel supplier systems 170 to participate in the reverse auction in order to compete to provide the best price to the user to attract the user's business to purchase fuel. Reverse auction manager 520 may set a time limit for the reverse auction and may determine the winner of the auction based on the lowest offered price. Reverse auction manager 520 may then identify fueling stations 180 associated with the fuel supplier that was able to offer the lowest price and may select the closest of the identified fueling stations 180 based on the location of vehicle 110.

Telematics interface 530 may be configured to communicate with telematics system 150. For example, telematics interface 530 may obtain telematics information relating to vehicle 110 from telematics system 150. In other implementations, telematics interface 530 may obtain telematics information relating to vehicle 110 directly from device 200. Fuel supplier system interface 540 may be configured to communicate with fuel supplier systems 170. For example, fuel supplier system interface 540 may obtain advertised fuel prices, personalized fuel prices, or fuel price bid offers for a reverse auction from fuel supplier systems 170.

User DB 560 may store information relating to particular users. For example, user DB 560 may store information relating a particular user and obtained from user DB 350 of device 200 associated with the particular user. Fueling station DB 560 may store information relating to particular fueling stations 180. For example, fueling station DB 560 store location information for a particular fueling station 180, a fuel supplier system 170 associated with the particular fueling station 180, contact information associated with the particular fueling station 180, offers, discounts, and/or coupons associated with the particular fueling station 180, and/or other information associated with the particular fueling station 180. Auction DB 570 may store information relating to reverse auctions generated by reverse auction manager 520. Exemplary information that may be stored in auction DB 570 is described below with reference to FIG. 6B.

Fueling station interface 580 may be configured to communicate with fueling stations 180. For example, fueling station interface 580 may contact fueling station 180 to obtain an offer, discount, and/or coupon associated with the fueling station 180. Furthermore, fueling station interface 580 may communicate with fueling station 180 in order to complete a fueling transaction associated with the user of vehicle 110.

Transaction module 590 may process a fueling transaction between the user of vehicle 110 and fueling station 180 and/or fuel supplier system 170. For example, transaction module 590 may identify a billing account associated with the user (e.g., based on information stored in user DB 560) and may bill or credit the billing account based on the fueling transaction. For example, transaction module 590 may apply a credit to the billing account based on a discount to a fuel price offered to the user by fuel supplier system 170.

Although FIG. 5 shows exemplary functional components of fuel auction system 160, in other implementations, fuel auction system 160 may include fewer functional components, different functional components, differently arranged functional components, or additional functional components than depicted in FIG. 5. Additionally, or alternatively, one or more functional components of fuel auction system 160 may perform functions described as being performed by one or more other functional components of fuel auction system 160.

FIG. 6A is a diagram illustrating exemplary components that may be stored in user DB 350. As shown in FIG. 6A, user DB 350 may include a user identifier (ID) field 610, a telematics data field 612, a vehicle data field 614, a fuel supplier accounts field 616, a fueling preferences field 618, and a billing account field 620.

User ID field 610 may store information identifying a particular user associated with device 200. For example, user ID field 610 may store a name associated with the particular user, an account number associated with the particular user, a mobile directory number (MDN) and/or another type of telephone number associated with the particular user, and/or other types of information that may be used to identify a user.

Telematics data field 612 may store telematics information associated with vehicle 110. For example, telematics data field 612 may store information identifying the location of vehicle 110, information identifying the speed and/or direction of vehicle 110, information identifying history of the fuel performance of vehicle 110, information identifying the fuel level of vehicle 110, an odometer reading associated with vehicle 110, and/or other types of telematics information. Vehicle data field 614 may store vehicle performance information associated with vehicle 110 (oil pressure, oil temperature, coolant temperature, battery voltage, battery current, emission status, speed, Revolutions Per Minute (RPM), acceleration, etc.), vehicle status information associated with vehicle 110 (e.g., OBD trouble codes, malfunction indicator light (MIL) status, etc.), and/or other types of vehicle information.

Fuel supplier accounts field 616 may include information identifying one or more fuel supplier accounts associated with the user. A fuel supplier account may be associated with a discount card, a rewards card, a credit card that provides fuel discounts, and/or another type of card or account number associated with a particular fuel supplier. Fuel supplier accounts field 616 may, for each fuel supplier account, identify the particular fuel supplier, identify an account number associated with the user, identify discounts or benefits associated with the fuel supplier account, identify purchase or transaction history associated with the user with respect to the particular fuel supplier, and/or may store other types of fuel supplier account.

Fueling preferences field 618 may store fueling preferences associated with the user. For example, fueling preferences field 618 may store preferred fuel brand information (e.g., a most preferred fuel brand, a second most preferred fuel brand, etc.), preferred fuel grade information (e.g., a most preferred fuel grade, a second most preferred fuel grade, etc.), and/or other types of fueling preferences information.

Billing account field 620 may store information identifying a billing account associated with the user. The user may receive a bill for services associated with the billing account at particular intervals (e.g., each month, etc.). For example, billing account field 620 may identify a wireless communication account associated with user device 130, a telematics services account associated with OBD device 120, and/or another type of account. The billing account may be used to bill or credit the user for fueling transactions processed by fueling application 300.

Although FIG. 6A shows exemplary components of user DB 350, in other implementations, user DB 350 may include fewer components, different components, differently arranged components, or additional components than depicted in FIG. 6A. For example, user DB 350 may include information indicating the number of people in vehicle 110. The information indicating the number of people in vehicle 110 may be obtained, for example, via proximity and/or weight sensors and via OBD device 120 in vehicle 110. The information indicating the number of people in vehicle 110 may be used as an incentive for fueling stations 180 to provide an additional fuel discount. Fueling station 180 may be more likely to extend a discount to a user in vehicle 110 if vehicle 110 includes more people (e.g., two or more people, three or more people, etc.), as more people may be more likely to make a purchase at fueling station 180 while vehicle 110 is being re-fueled.

FIG. 6B is a diagram illustrating exemplary components that may be stored in the auction DB 570. As shown in FIG. 6B, auction DB 570 may include one or more fuel auction records 630. Each fuel auction record 630 may store information relating to a particular fuel reverse auction generated by fuel auction system 160. Each fuel auction record 630 may include an auction ID field 632, a user ID field 634, a telematics field 636, one or more fueling station records 640, one or more fuel supplier records 650, and a final auction price record 660.

Auction ID field 632 may identify a particular reverse auction generated by fuel auction system 160. For example, each generated reverse auction may be assigned a unique auction ID. User ID field 634 may identify a particular user associated with the particular reverse auction (identified in Auction ID field 632). For example, user ID field 634 may include user identifying information included in a fuel price bid request and corresponding to at least some of the information stored in user ID field 610 of user DB 350 associated with the particular user.

Telematics field 636 may store telematics information associated with the particular user. The telematics information may be obtained from telematics system 150 or directly from device 200. For example, the telematics information may be included in the fuel price bid request that was used to generate the particular reverse auction. The telematics information may include the location of vehicle 110, the speed and direction of vehicle 110, and/or any other telematics information that may be available for vehicle 110 (e.g., information stored in telematics data field 612 and/or vehicle data field 614 of user DB 350 of device 200).

Each fueling station record 640 may store information relating a particular fueling station 180 identified by auction fuel system 160 based on the telematics information associated with vehicle 110. The information relating to the particular fueling station 180 may be obtained, for example, from fuel supplier system 170 associated with the particular fueling station 180. Fueling station record 640 may include a fueling station ID field 642, a fueling supplier ID field 644, a location field 646, and an offer field 648.

Fueling station ID field 642 may include information identifying the particular fueling station 180, such as a fueling station name, a fueling station number, and/or other types of identifying information. Fueling supplier ID field 644 may include information identifying the particular fuel supplier associated with the particular fueling station 180. Location field 646 may store information identifying the location of the particular fueling station 180. Offer field 648 may include one or more offers, discounts, and/or coupons received from the particular fueling station 180.

Each fuel supplier record 650 may store information relating a particular fuel supplier system 170 associated with a particular fueling station 180 identified in a fueling station record 640. Fuel supplier record 650 may include a fuel supplier ID field 652, an advertised price field 654, a personalized price field 656, and an auction price field 658.

Fuel supplier ID field 652 may identify a particular fuel supplier associated with one or more of the fueling stations 180 identified in fueling station records 640. Advertised price field 654 may include one or more advertised fuel prices associated with the particular fuel supplier (e.g., an advertised price for each fuel grade, etc.). Personalized price field 656 may include one or more personalized fuel prices for the user being offered by the particular fuel supplier. Auction price field 658 may include one or more auction prices offered by the particular fuel supplier during the reverse auction. Final auction price field 660 may store a currently lowest auction price based on the auction prices stored in auction price field 658. Furthermore, final auction price field 660 may store the final auction price after the reverse auction has ended based on the final currently lowest auction price.

Although FIG. 6B shows exemplary components of auction database 570, in other implementations, auction database 570 may include fewer components, different components, differently arranged components, or additional components than depicted in FIG. 6B.

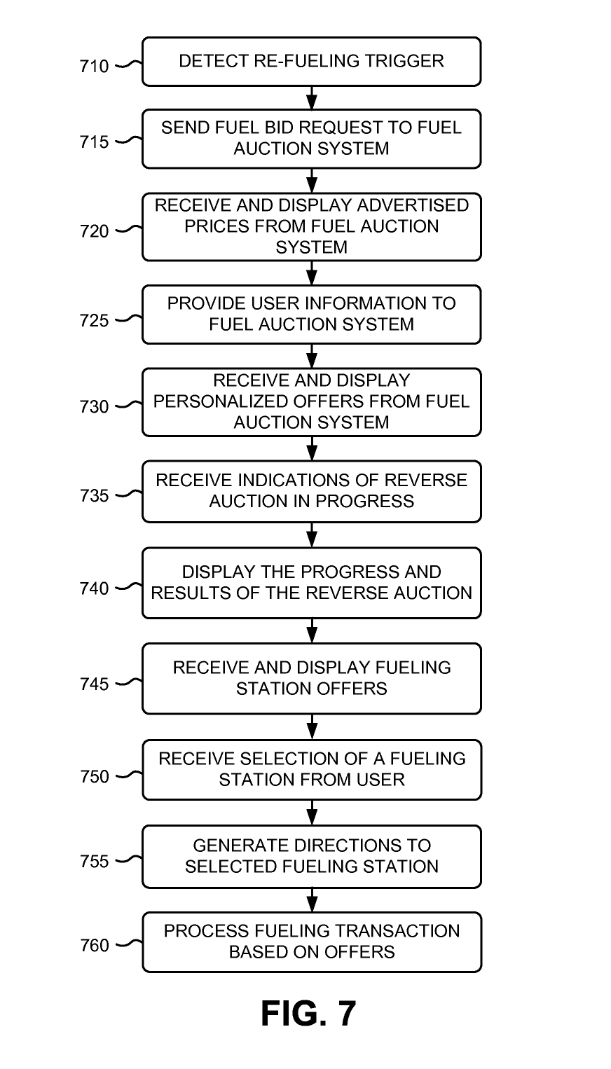

FIG. 7 is a flowchart of a first process of obtaining a fuel discount according to an implementation described herein. In some implementations, the process of FIG. 7 may be performed by vehicle computer device 115, OBD device 120, or user device 130, either individually or in combination. In other implementations, some or all of the process of FIG. 7 may be performed by another device or a group of devices separate from these devices. For example, some or all of the blocks of process of FIG. 7 may be performed by fuel auction system 160.

The process of FIG. 7 may include detecting a re-fueling trigger (block 710). For example, device 200 may detect a re-fueling trigger when the fuel level of vehicle 110 drops below a particular fuel level, based on detecting the activation of a low fuel level indicator; based on detecting of activation of a re-fueling dashboard button by the user; based on detecting activation of a fueling application; detection of a fueling station geo-fence associated with fueling station 180; and/or based on another type of re-fueling trigger.

In response to the detection of a re-fuelling trigger, a fuel bid request may be sent to a fuel auction system (block 715) and advertised prices may be received from the fuel auction system and displayed (block 720). For example, device 200 may send a fuel price bid request to fuel auction system 160 in response to the detected re-fueling trigger and may receive advertised fuel prices for fuel suppliers associated with identified fueling stations 180 within a particular range (e.g., 5 miles, 10 miles, etc.) of the location of vehicle 110. In some cases, the fueling station 180 and fuel supplier system 170 may be the same entity and thus fuel auction system 160 may only need to communicate with a fuel supplier server that may be operated by fueling station 180. In some implementations, the particular range may be based on a remaining driving distance estimated based on the fuel level of vehicle 110 and the fuel consumption rate of vehicle 110. Device 220 may generate a user interface and may display the received advertised prices in the user interface.

User information may be provided to the fuel auction system (block 725) and personalized offers may be received from the fuel auction system and displayed (block 730). For example, fuel auction system 160 may request user information from device 200 and user device may provide the requested user information. The user information may include, for example, information identifying the user and/or information identifying one or more fuel supplier accounts associated with the user, fuel preferences associated with the user, vehicle performance information, and/or vehicle status information. Device 200 may receive personalized offers from fuel auction system 160 based on the user information and may display the received personalized prices in the user interface.

Indications of a reverse auction in progress may be received (block 735) and the progress and results of the reverse auction may be displayed (block 740). For example, device 200 may receive an indication from fuel auction system 160 that a reverse auction has been generated and is in progress. Device 200 may receive real-time updates based on bid on fuel price received by fuel auction system 160 from fuel supplier systems 170 and forwarded to device 200. Thus, the user may observe the progress of the reverse auction on the user interface. Once the time allotted for the reverse auction has expired, or once a bid remains unchallenged for a particular length of time, device 200 may receive an indication that the reverse auction has ended along with the best price offered as a result of the reverse auction.

Fueling station offers may be received and displayed (block 745). For example, user device 200 may receive one or more offers, discounts, and/or coupons for particular fueling stations 180. As an example, a particular fueling station 180 may be willing to offer an additional discount in order to sell excess fuel, in order to increase business during a particular time period, in order to attract the user so the user makes additional purchases at fueling station 180, and/or for a different reason. For example, if fueling station 180 is provided with an indication that vehicle 110 includes multiple people, fueling station 180 may be willing to extend an additional fuel discount, as the multiple people may buy products (e.g., food or drinks) while vehicle 110 is being re-fueled. As another example, the particular fueling station 180 may offer a coupon for available services (e.g., an oil change, a car wash, etc.) or products (e.g., food and drink, motor oil, etc.) being sold at the particular fueling station 180.

It should be understood that the multiple offered discounts may be additive. For example, a personalized offer may include a first discount to an advertised fuel price, a reverse auction offer price may correspond to a second discount to the advertised fuel price, and a fueling station 180 discount may correspond to a third discount to the advertised fuel price, resulting in a final offer fuel price corresponding to the advertised fuel price minus the first discount, the second discount, and the third discount. Furthermore, in some implementations, multiple reverse auction discounts may be offered. For example, multiple reverse auctions may be performed and each reverse auction may result in a reverse auction discount. The multiple reverse auction discount may be added for a final offered discount.

A list of the fueling stations 180 and associated offered prices may be re-ordered based on one or more parameters in response to a user setting, a user selection, and/or in response to a fueling application 300 setting based on an instruction received from fuel auction system 160. For example, a user may select to order the list of fueling stations 180 based on the offered fuel price, based on a distance to vehicle 110, based on the user's fuel brand preferences, and/or based on another parameter. Additionally or alternatively, fueling application 300 may give a preferential listing (e.g., a higher position on the list) to a particular fueling station 180 based on the particular fueling station 180 being associated with a subsidized or advertised fuel brand. Furthermore, particular offers may be associated with a time limit. For example, a fuel price offered by a particular fuel supplier, or a discount offered by a particular fueling station 180, may expire after the time limit. Fueling application 300 may display a time limit in connection with a displayed offered price (e.g., “offered price good until 4:00 PM today”). Selection of a fueling station may be received from the user (block 750) and directions to the selected fueling station may be generated (block 755). The user may select a particular fueling station 180 based on the best offered fuel price. The best offered fuel price may be determined based on the results of the reverse auction and offers received for particular fueling stations 180. Alternatively, the user may select a fueling station 180 based on a combination of distance from vehicle 110 and offered price. Device 200 may generate navigation directions to the selected fueling station 180 based on the location of vehicle 110, based on the location of the selected fueling station 180, and based on a map of the geographic area of vehicle 110. Device 200 may activate a navigation/mapping application to generate the navigation instructions.

A fueling transaction may be processed based on the offers (block 760). For example, once the user drives the vehicle to the selected fueling station 180 and re-fuels, the user may pay for the transaction. Fueling station 180 may not be able to apply a discount to the advertised fuel prices to match the offer that the user received. Therefore, device 200 may, alone or in combination with fuel auction system 160, credit the user's billing account based on the difference between the advertised fuel prices charged at the fueling station 180 and the offer received by the user based on a reverse auction. Alternatively, rather than having to pay at fueling station 180, fuel auction system 160 may send a payment to fueling station 180 and may bill the user's account for the payment.

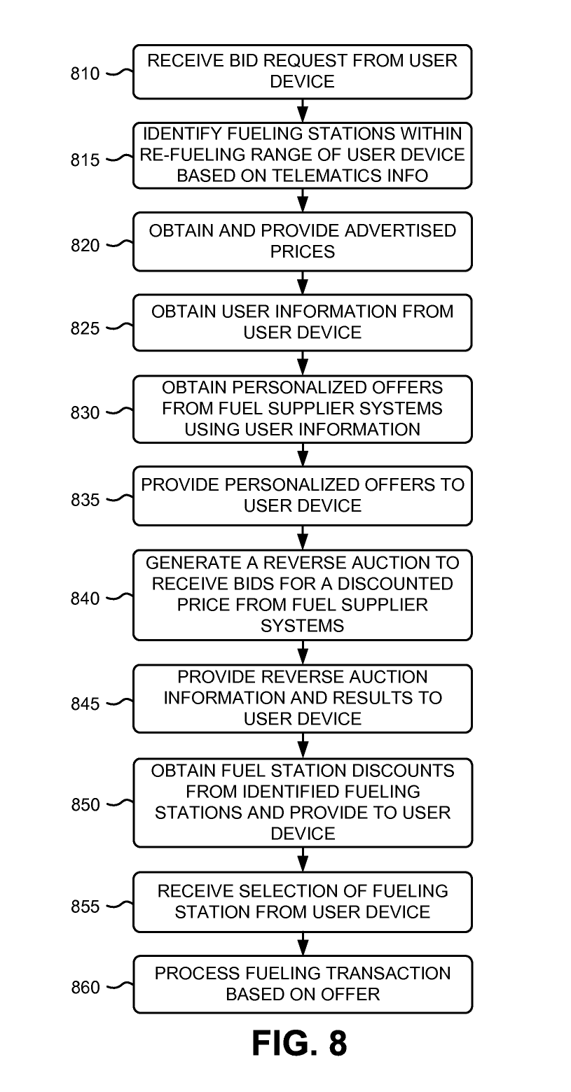

FIG. 8 is a flowchart of a process for generating a fuel discount using a reverse auction according to an implementation described herein. In some implementations, the process of FIG. 8 may be performed by fuel auction system 160. In other implementations, some or all of the process of FIG. 8 may be performed by another device or a group of devices separate from fuel auction system 160.

The process of FIG. 8 may include receiving a bid request from a user device (block 810) and identifying fueling stations within a re-fueling range of the user device based on telematics information associated with the vehicle in which the user device is located (block 815). For example, fuel auction system 160 may access fueling station DB 550 to identify fueling stations 180 within a particular range of vehicle 110 based on the location of vehicle 110. The location of vehicle 110 may be obtained based on telematics information sent to telematics system 150, or directly to fuel auction system 160, by vehicle computer device 115, OBD device 120, and/or user device 130.

The particular range may be based on a set distance (e.g., 3 miles, 5 miles, 10 miles, etc.) from the vehicle, may be set on a drivable distance for vehicle 110 based on the amount of fuel left, and/or may be based on other criteria. For example, the particular range may be based on context. If the user is driving in a city, based on the speed and location of vehicle 110, the particular range may be set to a first range (e.g., 3 miles, etc.), and if the user is driving on an interstate, the particular range may be sent to a second range (e.g., 20 miles, etc.). In some implementations, particular fueling stations 180 may be filtered out. For example, fueling stations 180 that are opposite to the direction of travel of vehicle 110 may be filtered out by fuel auction system 160 (and/or by fueling application 300), as a user may not be willing to turn around or backtrack to reach fueling station 180.

Advertised prices may be obtained and provided (block 820). For example, fuel auction system 160 may request advertised fuel prices for the identified fueling stations 180 from fuel supplier systems 170 and may provide the advertised fuel prices to device 200. User information may be obtained from the user device (block 825), personalized offers may be obtained from fuel supplier systems using the obtained user information (block 830), and the personalized offers may be provided to the user device (block 835). For example, fuel auction system 160 may obtain user information from device 200, such as user account information associated with fuel supplier accounts associated with the user, and may use the obtained user information to request personalized fuel prices from fuel supplier systems 170. Fuel auction system 160 may then provide the obtained personalized prices to device 200.

A reverse auction may be generated to receive bids for a discounted price from the fuel supplier systems (block 840) and may provide reverse auction information and results to the user device (block 845). For example, fuel auction system 160 may generate a reverse auction and may prompt fuel supplier systems 170 offer a better price, may inform each fuel supplier system 170 of the prices offered by other fuel supplier systems 170, and may obtain auction prices from fuel supplier systems 170. Fuel auction system 160 may send an indication to device 200 that a reverse auction is in progress and may continue to send updates to device 200 with received fuel price bid offers as the reverse auction progresses. The reverse auction may continue until an auction price stabilizes and no fuel supplier system 170 is offering a lower price than a current auction price or until the time allotted for the reverse auction runs out.

Fuel station discounts may be obtained from the identified fueling station and provided to the user device (block 850). For example, fuel auction system 160 may contact the identified fueling stations 180 to determine whether any of the identified fueling stations 180 are offering additional discounts, offers, or coupons and may provide any received discounts, offers, or coupons to device 200. Fueling station 180 may determine an additional discount based on information obtained by telematics system 150 and provided to fueling station 180 by fuel auction system 160. The telematics information may include the location information for the vehicle, historical location information associated with the vehicle, vehicle performance data for the vehicle, and/or other types of telematics information.

As explained above with reference to FIG. 7, multiple offered discounts obtained by fuel auction system 160 may be additive, such as a first discount to an advertised fuel price based on a personalized offer, a second discount to the advertised fuel price based on a reverse auction offer price, and a third discount to the advertised fuel price based on a fueling station 180 discount, resulting in a final offer fuel price corresponding to the advertised fuel price minus the first discount, the second discount, and the third discount. Furthermore, in some implementations, multiple reverse auction discounts may be offered. For example, multiple reverse auctions may be performed and each reverse auction may result in a reverse auction discount. The multiple reverse auction discount may be added for a final offered discount.

A selection of a particular fueling station may be received from the user device (block 855) and a fueling transaction may be processed based on an offer associated with the selected fueling station (block 860). For example, fuel auction system 160 may receive a selection of a fueling station 180 from device 200 and may receive, at a later time, an indication that the user has arrived at the selected fueling station 180 and is completing a fueling transaction at the selected fueling station 180. In response, fuel auction system 160 may apply a bill or a credit to a billing account associated with the user based on a difference between what the user pays for the fueling transaction at the selected fueling station 180 and the offered fuel price received by the user from fuel auction system 160. Alternatively, fuel auction system 180 may send a payment to the selected fueling station 180 and may bill the user's billing account.

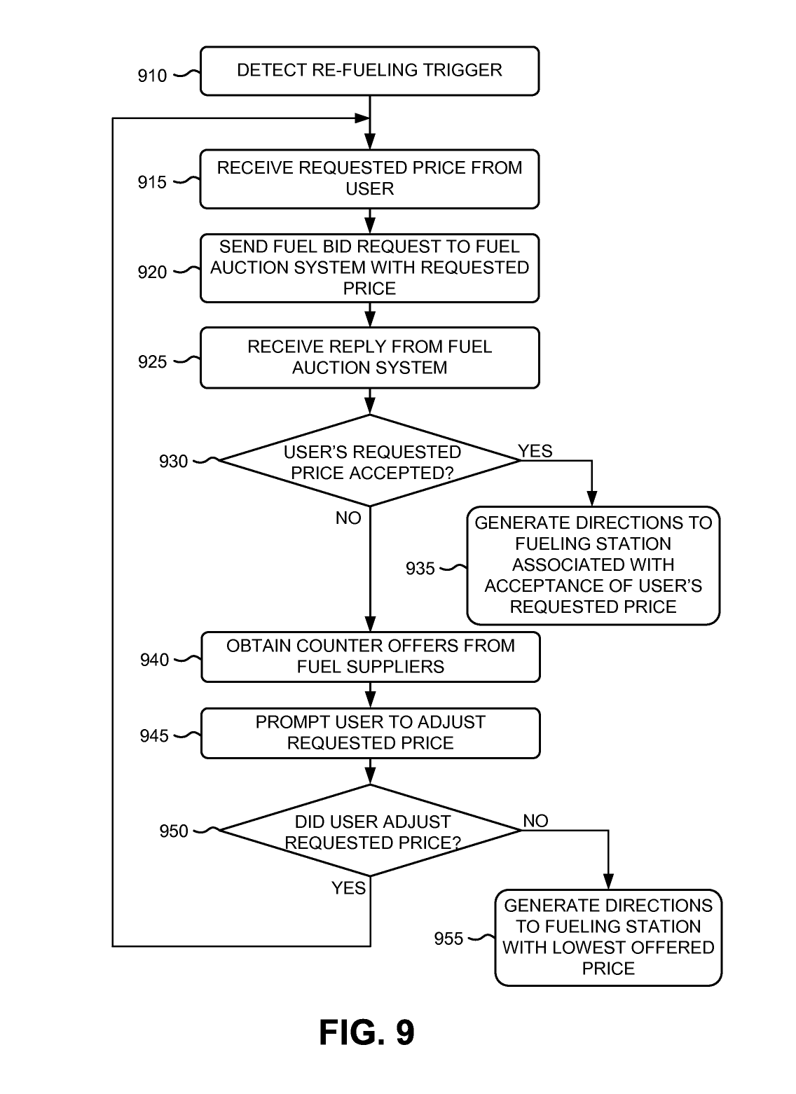

FIG. 9 is a flowchart of a second process of obtaining a fuel discount according to an implementation described herein. The process of FIG. 9 may enable a user to request a particular price in order to see whether the requested price is accepted by a fuel supplier or by a particular fueling station 180. In some implementations, the process of FIG. 9 may be performed by vehicle computer device 115, OBD device 120, or user device 130, either individually or in combination. In other implementations, some or all of the process of FIG. 9 may be performed by another device or a group of devices separate from these devices. For example, some or all of the blocks of process of FIG. 9 may be performed by fuel auction system 160.

The process of FIG. 9 may include detecting a re-fueling trigger (block 910). For example, device 200 may detect a re-fueling trigger when the fuel level of vehicle 110 drops below a particular fuel level, based on detecting the activation of a low fuel level indicator; based on detecting of activation of a re-fueling dashboard button by the user; based on detecting activation of a fueling application; detection of a fueling station geo-fence associated with fueling station 180; and/or based on another type of re-fueling trigger.

In response to the detected re-fueling trigger, a requested price may be received from the user (block 915), a fuel bid request may be sent to the fuel auction system with the requested price (block 920), and a reply may be received from the fuel auction system (block 925). For example, device 200 may receive user input indicating the user's requested price, may send the requested price to fuel auction system 160, and may receive a response back from fuel auction system 160 indicating whether the requested price has been accepted.

A determination may be made as to whether the user's requested price was accepted (block 930). If it is determined that the user's requested price was accepted (block 930—YES), directions may be generated to the fueling station associated with the acceptance of the user's requested price (block 935). For example, device 200 may select a fueling station 180 associated with a fuel supplier, or with a particular fueling station 180, that has accepted the user's price, and may generate navigation directions to the selected fueling station 180 based on the location of vehicle 110, based on the location of the selected fueling station 180, and based on a map of the geographic area of vehicle 110. Device 200 may activate a navigation/mapping application to generate the navigation instructions.

If it is determined that the user's requested price was not accepted (block 930—NO), counter offers may be obtained from the fuel suppliers (block 940) and the user may be prompted to adjust the requested price (block 945). For example, device 200 may prompt fuel supplier systems 170 to provide a counter offer price based on the user's requested price. For example, fuel supplier system 170 may provide a counter offer price that is higher than the user's requested price, but lower than an advertised or previously offered fuel price. Device 200 may provide any counter offers to the user and may prompt the user to raise the requested price in order to receiving an accepting reply. A determination may be made as to whether the user has adjusted the requested price (block 950). If it is determined that the user has adjusted the requested price (block 950—YES), processing may return to block 915 to repeat the process of receiving a requested price from the user and sending the requested price to the fuel auction system.

If it is determined that the user has not adjusted the requested price (block 950—NO), the user may be informed of the best available price and directions may be generated to a fueling station with the lowest offered price (block 955). In some implementations, the lowest offered price may be based on advertised prices, may be based on a personalized price offered to the user, and/or may be based on an auction price based on the results of a reverse action generated by fuel auction system 160. In other words, device 200 may execute the process of FIG. 7 in response to the user not adjusting the user's requested price.

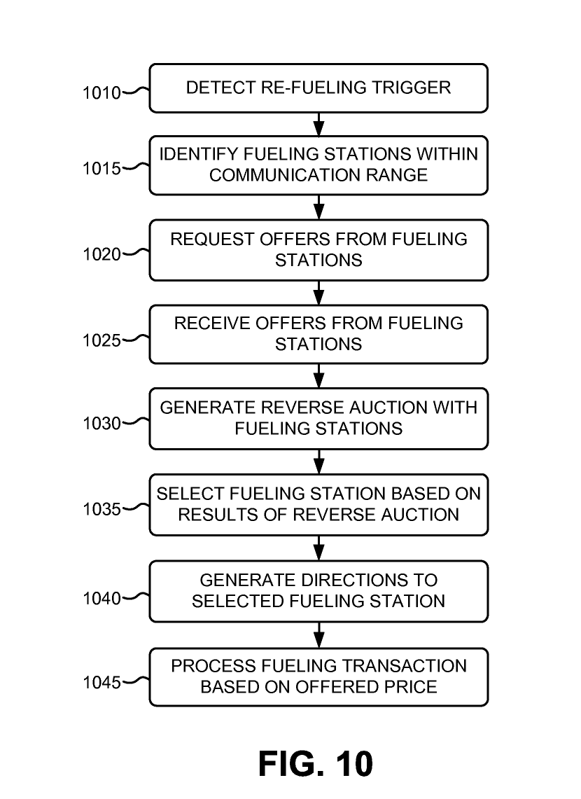

FIG. 10 is a flowchart of a third process of obtaining a fuel discount according to an implementation described herein. The process of FIG. 10 may enable a user to communicate directly with fueling stations 180 in order to determine the best obtainable fuel price in the geographic area of vehicle 110. In some implementations, the process of FIG. 10 may be performed by vehicle computer device 115, OBD device 120, or user device 130, either individually or in combination. In other implementations, some or all of the process of FIG. 10 may be performed by another device or a group of devices separate from these devices.

The process of FIG. 10 may include detecting a re-fueling trigger (block 1010). For example, device 200 may detect a re-fueling trigger when the fuel level of vehicle 110 drops below a particular fuel level, based on detecting the activation of a low fuel level indicator; based on detecting of activation of a re-fueling dashboard button by the user; based on detecting activation of a fueling application; detection of a fueling station geo-fence associated with fueling station 180; and/or based on another type of re-fueling trigger.

In response to detecting the re-fueling trigger, fueling stations 180 within a communication range may be identified (block 1015). For example, device 200 may send a re-fueling query, using a wireless communication method (e.g., WiFi, Bluetooth, etc.), requesting a response from any fueling stations 180 within range (e.g., within range of a receiver that receives such short range wireless requests). Fueling stations 180 may be configured to detect re-fueling queries from user devices. As an example, a re-fueling negotiation protocol may be established using a particular communication protocol and device 200 and fueling stations 180 may be configured to recognize messages associated with the re-fueling negotiation protocol. As another example, fueling station 180 may include a WiFi access point and may enable devices 200 to wirelessly connect to the WiFi access point. Once device 200 is connected to WiFi access point, fueling application 300 may send a fuel bid request to fueling station 180 using the WiFi access point. For example, a user may be in the vicinity of an intersection that includes multiple fueling stations 180 and may be able to establish a WiFi connection with multiple fueling stations 180.

In other implementations, fueling stations 180 may be selected based on being within a geographic area based on the remaining driving distance of vehicle 110 and the selected fueling stations 180 may be contacted with a different communication method, such as by sending messages to the selected fueling stations 180 using wireless signals sent via base station 145. For example, device 200 may obtain telephone numbers, email addresses, and/or other types of contact information for fueling stations 180 and may send a message, such as an SMS message or an email message, to the selected fueling stations 180. Fueling station 180 may then send a message indicating which pump vehicle 110 should drive up to, and may furthermore reserve the pump for vehicle 110 based on as location information transmitted from vehicle 110.

Offers may be requested from the fueling stations (block 1020) and offers may be received from the fueling stations in response (block 1025). For example, device 200 may send a fuel bid request to each identified fueling station 180 and the fueling stations 180 may respond with an advertised fuel price. A reverse auction may be generated with the fueling stations (block 1030). For example, re-fueling manager 320 may generate a reverse auction and may send requests to the identified fueling stations 180 to bid with a lower fuel price offer. One or more of the identified fueling stations 180 may respond with a lowered price. Re-fueling manager 320 may repeat the request until the offer price stabilizes and no more offers are received from the identified fueling stations 180.

A fueling station may be selected based on the results of the reverse auction (block 1035), directions to the selected fueling station may be generated (block 1040), and a fueling transaction may be processed based on the offered price (block 1045). For example, the user may select fueling station 180 based on the offers received and device 200 may generate navigation directions to the selected fueling station 180. Furthermore, the user may be able to use fueling application 300 or a payment application to pay for the fueling transaction.

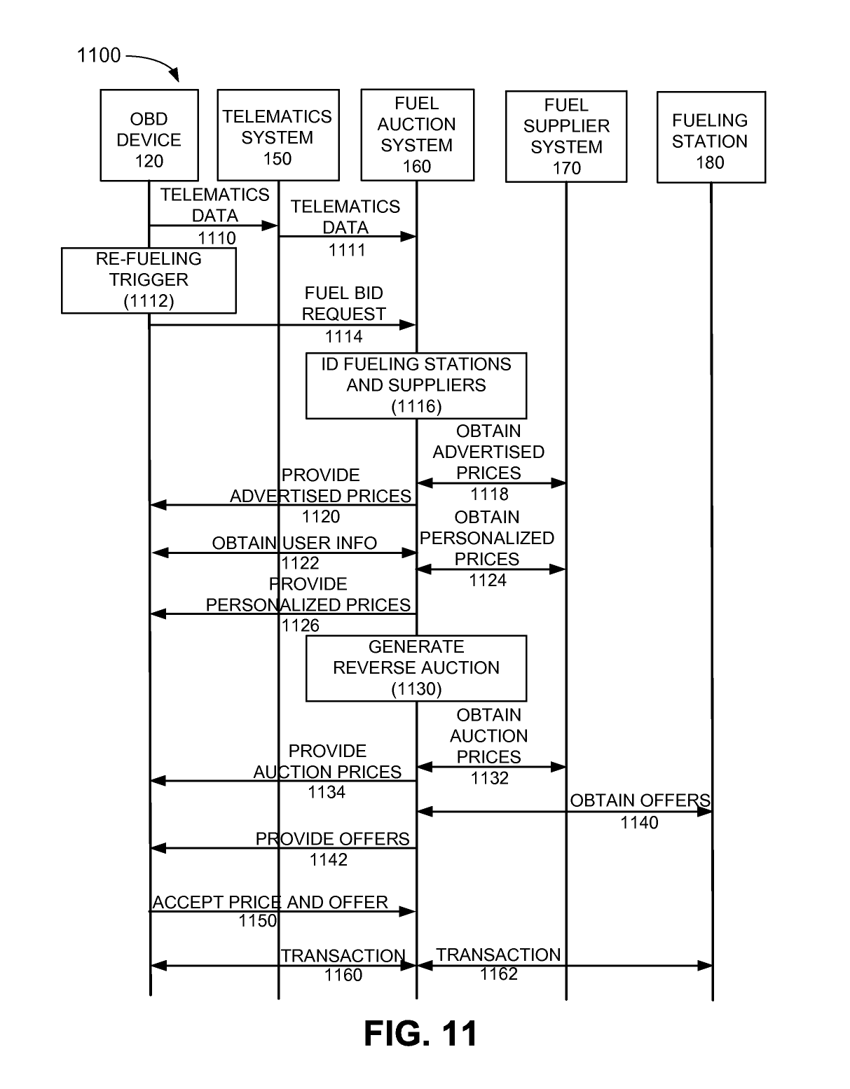

FIG. 11 is an exemplary signal flow diagram 1100 according to an implementation described herein. Signal flow diagram 1100 may include OBD device 120 providing, at particular intervals, telematics data, including the location, speed, and direction of vehicle 110, to telematics system 150 and telematics system 150 may provide the telematics data to fuel auction system 160 (signals 1110 and 1111). OBD device 120 may detect a re-fueling trigger (block 1110). For example, OBD device 120 may detect that a low fuel indicator has been activated. In response, OBD device 120 may send a fuel bid request 1114 to fuel auction system 160 (signal 1114).

Fuel auction system 160 may, in response, identify fueling stations 180 and may identify associated fuel suppliers within a particular range of the location of vehicle 110 (block 1116). Fuel auction system 160 may obtain advertised fuel prices for the fueling stations 180 from fuel supplier systems 170 (signal 1118) and may provide the advertised fuel prices to OBD device 120 (signal 1120). OBD device 120 may generate a user interface and display information identifying the fuel suppliers and the received advertised fuel prices. In some implementations, the user interface may be displayed on a dashboard display of vehicle 110. In other implementations, the user interface may be displayed on the screen of another device (e.g., user device 130) via a short range wireless communication method, such as Bluetooth or WiFi, or via a long range wireless data link using base station 145.

Fuel auction system 160 may obtain user information from OBD device 120, such as user account information associated with fuel supplier accounts associated with the user (signal 1122) and may use the obtained user information to obtain personalized fuel prices from fuel supplier systems 170 (signal 1124). Fuel auction system 160 may then provide the obtained personalized prices to OBD device 120 (signal 1126) and OBD device 120 may display the personalized prices in the generated user interface.

Fuel auction system 160 may then generate a reverse auction (block 1130) in an attempt to obtain a better price for the user. Fuel auction system 160 may prompt fuel supplier systems 170 offer a better price, may inform each fuel supplier system 170 of the prices offered by other fuel supplier systems 170, and may obtain auction prices from fuel supplier systems 170 (signal 1132). Fuel auction system 160 may provide the auction prices to OBD device 120 (signal 1134) and OBD device 120 may display the auction prices in the generated user interface. The process of obtaining the auction prices and providing them to OBD device 120 may be repeated until an auction price stabilizes and no fuel supplier system 170 is offering a lower price than a current auction price or until the time allotted for the reverse auction runs out. The user may thus be provided with the final auction price.

Furthermore, fuel auction system 160 may contact the identified fueling stations 180 to determine whether any of the identified fueling stations 180 are offering additional discounts, offers, or coupons (signal 1140) and may provide any received discounts, offers, or coupons to OBD device 120 (signal 1142). OBD device 120 may display the received discounts, offers, or coupons in the generated user interface. The user may accept the auction price and may select a fueling station 180 associated with the best price (signal 1150). Once the user arrives at the selected fueling station 180, a fueling transaction may be processed by fuel auction system 170 between OBD device 200 and the selected fueling station 180.

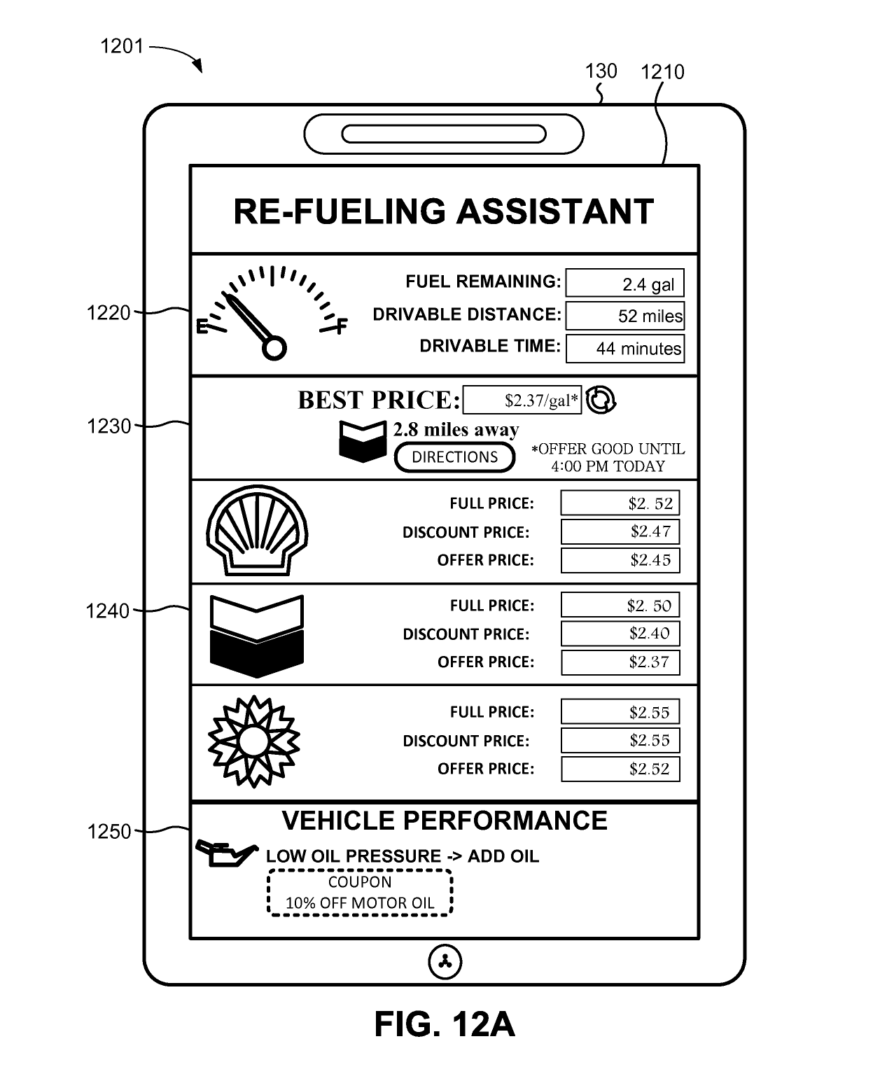

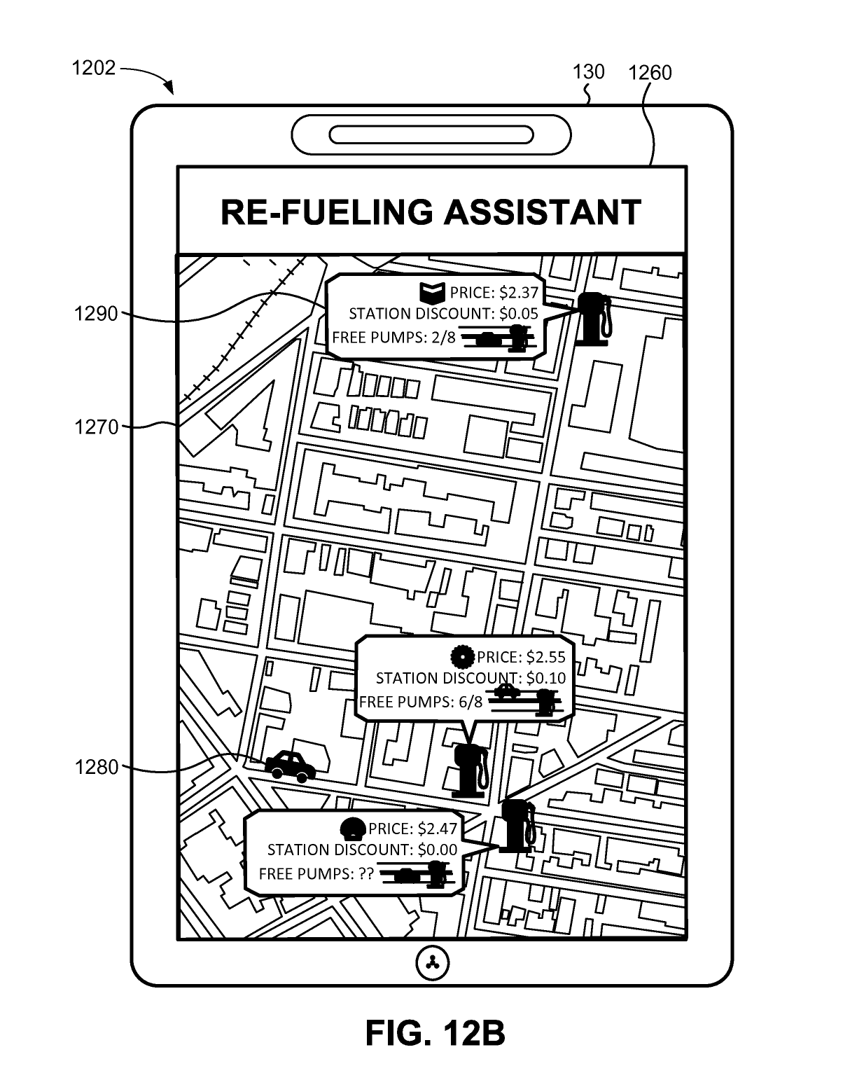

FIGS. 12A and 12B are exemplary diagrams of user interfaces that may be generated when device 200 corresponds to user device 130 and when fueling application 300 is installed on user device 130. FIG. 12A is a diagram of a first exemplary user interface 1201 according to an implementation described herein. As shown in FIG. 12A, user device 130 may include a display 1210 that includes a fuel information area 1220, a best price area 1230, a fuel suppliers area 1240, and an offers area 1250.

Fuel information area 1220 may display fuel information for vehicle 110. The fuel information may include the remaining fuel, the drivable distance based on the fuel level and based on a current fuel consumption rate, and a drivable time based on the drivable distance and the current speed of vehicle 110. The fuel information may be obtained from vehicle computer system 115 and/or from OBD device 120 using wireless signals.

Best price area 1230 may display a current best fuel price based on a fuel price reverse auction and/or based on fuel price offers received by user device 130 from fuel auction system 160. The current best price may be displayed along with an indication as to whether a reverse auction is still in progress. Furthermore, best price area 1230 may include information identifying how far a fueling station 180 associated with the best price is as well as a button to request navigation directions to the identified fueling station 180. Furthermore, best price area 1230 may include an indication of a time limit associated with a fuel price offer.

Fuel suppliers area 1240 may include information for each fuel supplier from which an offer has been received. For each fuel supplier, the displayed prices may include an advertised price (e.g., “full price), a personalized offer price (e.g., “discount price”), and an offer price received based on the reverse auction (e.g., “offer price”). Offers area 1250 may include discounts, offers, and/or coupons received from particular fueling stations 180. Furthermore, offers area 1250 may include vehicle performance information, such as any indications from diagnostics trouble codes.

FIG. 12B is a diagram of a second exemplary user interface 1202 according to an implementation described herein. As shown in FIG. 12B, user device 130 may include a display 1260 that includes a map 1270 of the geographic area in which vehicle 110 is located. Map 1270 may include a vehicle icon 1280 that indicates the location of vehicle 110. Furthermore, map 1270 may include fueling station tooltips 1290 for each fueling station 180 in the geographic area that was identified by fuel auction system 160. Each fueling station tooltip 1290 may include information identifying a fuel supplier associated with fueling station 180 (e.g., using a fuel supplier logo), may include a price offered by the fueling supplier, and may include a fueling station discount offered by the fueling station on top of the price offered by the fueling supplier.

Furthermore, fueling station tooltip 1290 may include information identifying a number of unoccupied or available pumps at the fueling station, information indicating which side of the street fueling station 180 is located in relation to the driving direction of vehicle 110, and/or whether fueling station 180 is in a direction of travel. The number of unoccupied or available pumps may be determined by, for example, proximity sensors located near each pump and the information relating to the number of free pumps may be provided by fueling station 180 to fuel auction system 160. As another example, the number of free pumps may be estimated based on information obtained from fueling applications 300 of other users re-fueling at fueling station 180.

While FIGS. 12A and 12B illustrate user interfaces 1201 and 1202 shown on user device 130 (e.g., in a portrait mode aspect ratio), in other implementations, user interfaces 1201 and 1202 may be implemented in a dashboard display receiving display information from vehicle computer device 115 and/or OBD device 120 and be displayed using a different aspect ratio (e.g., in a landscape mode aspect ratio).

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

As an example, while series of blocks have been described with respect to FIGS. 7-10, and series of signal flows have been described with respect to FIG. 11, the order of the blocks and/or signal flows may be modified in other implementations. Further, non-dependent blocks may be performed in parallel.

It will be apparent that systems and/or methods, as described above, may be implemented in many different forms of software, firmware, and hardware in the implementations illustrated in the figures. The actual software code or specialized control hardware used to implement these systems and methods is not limiting of the embodiments. Thus, the operation and behavior of the systems and methods were described without reference to the specific software code—it being understood that software and control hardware can be designed to implement the systems and methods based on the description herein.

Further, certain portions, described above, may be implemented as a component that performs one or more functions. A component, as used herein, may include hardware, such as a processor, an ASIC, or a FPGA, or a combination of hardware and software (e.g., a processor executing software).

It should be emphasized that the terms “comprises”/“comprising” when used in this specification are taken to specify the presence of stated features, integers, steps or components but does not preclude the presence or addition of one or more other features, integers, steps, components or groups thereof.

The term “logic,” as used herein, may refer to a combination of one or more processors configured to execute instructions stored in one or more memory devices, may refer to hardwired circuitry, and/or may refer to a combination thereof. Furthermore, logic may be included in a single device or may be distributed across multiple, and possibly remote, devices.

For the purposes of describing and defining the present invention, it is additionally noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used in the present application should be construed as critical or essential to the embodiments unless explicitly described as such. Also, as used herein, the article “a” is intended to include one or more items. Further, the phrase “based on” is intended to mean “based, at least in part, on” unless explicitly stated otherwise.

What is claimed is:

1. A method, performed by a computer device, the method comprising:
detecting, by the computer device, a re-fueling trigger for a vehicle, wherein the computer device is located inside the vehicle;
sending, by the computer device via a network and in response to the detecting the re-fueling trigger, a fuel bid request to a fuel auction system for fuel prices within a geographic area based on a location of the vehicle;
receiving, by the computer device via the network, information relating to a fuel price reverse auction generated by the fuel auction system in response to the fuel bid request;
generating, by the computer device, a user interface that displays the received information relating to the fuel price reverse auction, wherein the information includes variable discount fuel prices associated with a plurality of fueling stations within the geographic area;
receiving, by the computer device via the network, information relating to the results of the fuel price reverse auction from the fuel auction system;
displaying, by the computer device, the received information relating to the results of the fuel price reverse auction in the generated user interface; and
receiving, by the computer device, selection of a fueling station via the user interface based on the results of the fuel price reverse auction.

2. The method of claim 1, wherein detecting the re-fueling trigger for the vehicle includes at least one of:
activation of a low fuel level indicator;
activation of a re-fueling dashboard button;
activation of a fueling application; or
detection of a fueling station geo-fence.

3. The method of claim 1, further comprising:
receiving advertised fuel prices associated with the fueling stations within the geographic area from the fuel auction system; and
displaying the received the advertised fuel prices in the generated user interface.

4. The method of claim 1, further comprising:
sending user information associated with a user of the vehicle to the fuel auction system, wherein the user information includes information identifying one or more fuel supplier accounts associated with the user;
receiving, from the fuel auction system, personalized fuel prices associated with the fueling stations within the geographic area, in response to sending the user information; and
displaying the received the personalized fuel prices in the generated user interface.

5. The method of claim 1, further comprising:
determining fuel preferences associated with a user of the vehicle; and
adjusting the user interface based on the determined fuel preferences.

6. The method of claim 1, further comprising:
receiving, from the fuel auction system, a discount associated with a particular fueling station; and
applying the received discount to a price displayed in associated with the particular fueling station in the user interface.

7. The method of claim 1, further comprising:
sending payment for a fueling transaction to the selected fueling station via the fuel auction system, wherein sending the payment includes billing a wireless communication account associated with a user of the computer device.

8. The method of claim 1, wherein the computer device includes:
an embedded telematics device included in the vehicle;
an on-board diagnostics device plugged into an on-board diagnostics port of the vehicle; or
a portable wireless communication device located inside the vehicle.

9. The method of claim 1, wherein the user interface includes, for a particular fueling station of the plurality of fueling stations, one or more of:
an offered price associated with the particular fueling station;
a fuel supplier associated with the particular fueling station;
a distance to the particular fueling station;
a coupon associated with the particular fueling station;
a number of unoccupied vehicle fueling spots associated with the particular fueling station;
whether the particular fueling station is on a same side of the street as the vehicle, or
whether the particular fueling station is in a direction of travel.

10. The method of claim 1, further comprising:
providing vehicle telematics data to the fuel auction system, wherein the vehicle telematics data includes at least one of:
the location of the vehicle;
information relating to a most recent stop of the vehicle;
demographic information associated with a user of the vehicle;
a vehicle type for the vehicle; or
a size of a fuel tank for the vehicle.

11. The method of claim 1, further comprising:
receiving, via the user interface, a requested fuel price from the user;
providing the requested fuel price to the fuel auction system;
receiving, from the fuel auction system, a response indicating whether the requested fuel price was accepted by at least one of the plurality of fueling stations.

12. The method of claim 1, further comprising:
identifying a particular fueling station within wireless communication range of the computer device;
sending a fuel price offer request to the identified particular fueling station; and
receiving, from the particular fueling station, a fuel price offer based on the fuel price offer request.

13. A computer device comprising:
logic configured to:
detect a re-fueling trigger for a vehicle, wherein the computer device is located inside the vehicle;
send, via a network, a fuel bid request to a fuel auction system for fuel prices within a geographic area based on a location of the vehicle;
receive, via the network, information relating to a fuel price reverse auction generated by the fuel auction system in response to the fuel bid request;
generate a user interface that displays the received information relating to the fuel price reverse auction, wherein the information includes variable discount fuel prices associated with a plurality of fueling stations within the geographic area;
receive, via the network, information relating to the results of the fuel price reverse auction from the fuel auction system;
display the received information relating to the results of the fuel price reverse auction in the generated user interface; and
receive selection of a fueling station via the user interface based on the results of the fuel price reverse auction.

14. The computer device of claim 13, wherein the logic is further configured to:
receive advertised fuel prices associated with the fueling stations within the geographic area from the fuel auction system;
display the received the advertised fuel prices in the generated user interface;
send user information associated with a user of the vehicle to the fuel auction system, wherein the user information includes information identifying one or more fuel supplier accounts associated with the user;
receive, from the fuel auction system, personalized fuel prices associated with the fueling stations within the geographic area, in response to sending the user information; and
display the received the personalized fuel prices in the generated user interface.

15. The computer device of claim 13, wherein the computer device includes:
an embedded telematics device included in the vehicle;
an on-board diagnostics device plugged into an on-board diagnostics port of the vehicle; or
a portable wireless communication device located inside the vehicle.

16. A method, performed by a computer device, the method comprising:
receiving, by the computer device via a network, a fuel bid request from a user device for fuel prices within a geographic area of a vehicle associated with the user device;
obtaining, by the computer device, location information for the vehicle from a vehicle telematics system;
identifying, by the computer device, a plurality of fueling stations within the geographic range based on the location information associated with the vehicle and based on a computed driving distance for the vehicle based on a fuel level for the vehicle;
identifying, by the computer device, a plurality of fuel suppliers associated with the plurality of fueling stations;
generating, by the computer device, a fuel price reverse auction for the plurality of fuel suppliers;
providing, by the computer device via the network, information relating to the generated fuel price reverse auction to the user device;
determining, by the computer device, results of the fuel price reverse auction;
providing, by the computer device via the network, the determined results of the fuel price reverse auction to the user device;
receiving, by the computer device via the network, a selection of a fueling station from the plurality of fueling stations from the user device based on the provided results of the fuel price reverse auction; and
processing, by the computer device, a fueling transaction between the selected fueling station and a user associated with the user device.

17. The method of claim 16, further comprising:
obtaining advertised fuel prices from the identified plurality of fuel suppliers; and
providing the obtained advertised fuel prices to the user device.

18. The method of claim 16, further comprising:
obtaining user information for the user from the user device, wherein the user information includes information identifying one or more fuel supplier accounts associated with the user;
obtaining, from at least one of the plurality of fuel suppliers, a personalized fuel price based on the obtained user information; and
providing the personalized fuel price to the user device.

19. The method of claim 16, further comprising:
obtaining, from at least one of the plurality of fueling stations, a discount offer based on telematics information obtained from the telematics system, wherein the telematics information includes at least one of:
the location information for the vehicle;
historical location information associated with the vehicle;
vehicle performance data for the vehicle; and
providing the discount offer to the user device.

20. The method of claim 16, wherein processing the fueling transaction between the selected fueling station and the user associated with the user device includes at least one of:
billing an account associated with the user; or
applying a discount to a bill for an account associated with the user based on the fueling transaction.
